(19) United States
(12) Patent Application Publication
(10) Pub. No.: US 2006/0126128 A1
(43) Pub. Date: Jun. 15, 2006

(54) Scanning assembly

(75) Inventors: Mohamed N. Ahmed, Louisville, KY (US); Michael E. Lhamon, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/013,522

(22) Filed: Dec. 15, 2004

(51) Int. Cl. H04N 1/04

(52) U.S. Cl. 358/474

(57) ABSTRACT

A first scanning assembly includes a scanner and a projector, wherein the scanner is adapted for scanning a document, and wherein the projector is operatively connected to the scanner and is adapted for optically projecting a preview of a scan of a document scanned by the scanner. A second scanning assembly includes a scanner and a projector, wherein the scanner is adapted for generating an input panel image, and wherein the projector is operatively connected to the scanner and is adapted for optically projecting the input panel image.

### TECHNICAL FIELD

The present invention relates generally to scanning documents, and more particularly to a scanning assembly.

### BACKGROUND OF THE INVENTION

Scanners include standalone scanners and those scanning part of printer, copiers, facsimile machines, and all-in-one machines. A known scanner includes a small display screen for displaying a preview of a scanned document, and a known photographic film scanner includes a small interactive touch screen for displaying a preview of a scan, for changing the brightness and contrast of a scan, and for choosing the destination (e.g., save to disk) of a scan.

What is needed is an improved scanning assembly.

### SUMMARY OF THE INVENTION

A first expression of an embodiment of the invention is for a scanning assembly including a scanner and a projector. The scanner is adapted for scanning a document. The projector is operatively connected to the scanner and is adapted for optically projecting a preview of a scan of a document scanned by the scanner. Examples of scanners include, without limitation, flat-bed scanners and automatic-document-feeder (ADF) scanners.

A second expression of an embodiment of the invention is for a scanning assembly including a scanner and a projector. The scanner is adapted for generating an input panel image. The projector is operatively connected to the scanner and is adapted for optically projecting the input panel image.

A third expression of an embodiment of the invention is for a scanning assembly including a scanner and at least one projector. The scanner is adapted for scanning a document and for generating an input panel image. The at least one projector is operatively connected to the scanner and is adapted for optically projecting a preview of a scan of a document scanned by the scanner and for optically projecting the input panel image.

In one example, optically projecting a preview of a scan of a document provides a relatively large size preview of the scan to enable the user to better determine any adjustments the user wants the scanner to make (such as adjustments to the brightness and contrast) of the scan before the user determines a desired destination for the scan. In the same or a different example, optically projecting a relatively large-size input panel image enables the user to more easily interact with the scanner such as, in one arrangement, by using a pointing device.

### BRIEF DESCRIPTION OF THE DRAWINGS

FIG. 1 is a schematic, perspective view of an embodiment of a scanner assembly of the invention;

FIG. 2 is a schematic, side-elevational cutaway view of an embodiment of a portion of the scanner and of a first embodiment of the projector of the scanner assembly of FIG. 1; and

FIG. 3 is a schematic, side-elevational cutaway view of an embodiment of a portion of the scanner and of a second embodiment of the projector of the scanner assembly of FIG. 1.

### DETAILED DESCRIPTION

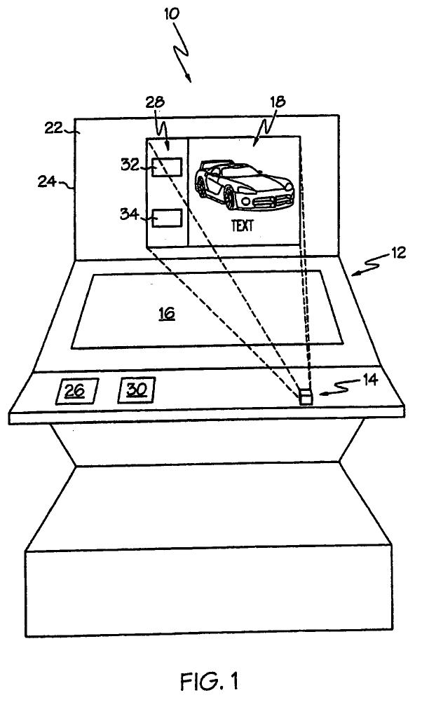

An embodiment of a scanner assembly 10 of the invention is shown in FIG. 1. A first expression of the embodiment of FIG. 1 is for a scanner assembly 10 including a scanner 12 and a projector 14. The scanner 12 is adapted for scanning a document 16. The projector 14 is operatively connected to the scanner 12 and is adapted for optically projecting a preview 18 of a scan of the document 16 scanned by the scanner 12. Examples of document 16 include, without limitation, text documents, graphics documents, mixed text-and-graphics documents, and photographs.

In one implementation of the first expression of the embodiment of FIG. 1, the scanning assembly 10 is a scanning assembly of an all-in-one machine. For purposes of describing the embodiment of FIG. 1, an “all-in-one machine” is a machine adapted to function as at least two different devices, wherein a list of different devices includes a printer (such as an inkjet printer), a copier, a scanner (also called an optical scanner), a facsimile device, and a card reader (such as a photo card reader) in a stand alone mode.

In one enablement of the first expression of the embodiment of FIG. 1, the scanner 12 includes a substantially flat surface 22, and the projector 14 is adapted for optically projecting the preview 18 onto the substantially flat surface 22. In one variation, the scanner 12 includes a platen cover 24, and the substantially flat surface 22 is a substantially flat surface of the platen cover 24. In one modification, the platen cover 24 is hinged and includes an open position substantially perpendicular to the document placement platen, wherein the substantially flat surface 22 is the inside surface of the platen cover 24. In another enablement, not shown, the substantially flat surface is a wall of a room containing the scanner assembly 10. Other enablements are left to the artisan.

In one arrangement of the first expression of the embodiment of FIG. 1, the scan has a parameter observable from the projected preview 18, and the scanner 12 also includes a user-interactive input device 26 adapted to adjust the parameter. In one variation, the parameter is chosen from the group consisting of brightness, contrast, cropping, scaling (e.g., scaling from legal size to letter size), and translation (e.g., moving the image to avoid staple locations and/or punch-hole locations). In one variation, the user-interactive input device 26 includes hardware buttons to increase and to decrease brightness and contrast. In another variation, the user-interactive input device 26 includes a relatively small touch screen displaying touch buttons to increase and to decrease brightness and contrast. In yet other variations, the user-interactive input device 26 includes hardware or touch buttons to perform other functions, such as cropping, scaling or translating. Other variations are left to those skilled in the art.

In one application of the first expression of the embodiment of FIG. 1, the projected preview 18 has an area of at least twenty-five percent of the area of the document 16. In one example, optically projecting a preview 18 of a scan of a document 16 provides a relatively large size preview 18 of the scan to enable the user to better determine any adjustments the user wants the scanner 12 to make (such as adjustments to the brightness or contrast) of the scan before the user determines a desired destination for the scan. In one variation, the projection distance is no more than three feet which can still provide a relatively large preview 18 and which can provide a high resolution preview 18 without requiring the projector 14 to employ a high intensity light source.

A second expression of the embodiment of FIG. 1 is for a scanner assembly 10 including a scanner 12 and a projector 14. The scanner 12 is adapted for generating an input panel image 28. The projector 14 is operatively connected to the scanner 12 and is adapted for optically projecting the input panel image 28.

In one implementation of the second expression of the embodiment of FIG. 1, the scanning assembly 10 is a scanning assembly of an all-in-one machine.

In one enablement of the second expression of the embodiment of FIG. 1, the scanner 12 includes a substantially flat surface 22, and the projector 14 is adapted for optically projecting the input panel image 28 onto the substantially flat surface 22. In one variation, the scanner 12 includes a platen cover 24, and the substantially flat surface 22 is a substantially flat surface of the platen cover 24.

In one arrangement of the second expression of the embodiment of FIG. 1, the scanning assembly 10 includes a pointing device 30 adapted for user interaction with the projected input panel image 28. In one variation, the projected input panel image 28 includes a cursor, and the pointing device 30 includes hardware buttons (such as left, right, up, and down arrow hardware buttons to move the cursor and an “enter” or “click” hardware button) for the user to interact with the projected input panel image 28. It is noted that the term ‘cursor’ includes those cursors which are superimposed on image objects of the projected input panel image and those cursors which highlight image objects of the projected input panel image. In another variation, the projected input panel image 28 includes a cursor, and the pointing device 30 is a touch screen which displays touch buttons (such as left, right, up, and down arrow touch buttons to move the cursor and an “enter” or “click” touch button) for the user to interact with the projected input panel image 28. Additional examples of pointing devices 30 which use a cursor include, without limitation, a computer mouse, a trac-ball mouse, a joy stick, and those employing a laser pointer. In yet other variations, no cursor is used. Examples of pointing devices 30 which do not use a cursor include, without limitation, a light pen and a touch screen upon which the input panel image is projected.

In one illustration of the second expression of the embodiment of FIG. 1, the projected input panel image 28 includes a scan-parameter panel-button image portion 32 chosen from the group consisting of a brightness panel-button image portion, a contrast panel-button image portion, a cropping panel-button image portion, a scaling panel-button image portion, and a translation panel-button image portion. In the same or a different illustration, the projected input panel image 28 also includes a scan-destination panel-button image portion 34 chosen from the group consisting of an email-destination panel-button image portion, a facsimile-destination panel-button image portion, and a print-destination panel-button image portion.

In one application of the second expression of the embodiment of FIG. 1, the projected input panel image 28 has an area of at least one hundred square inches. In one example, optically projecting a relatively large-size input panel image 28 enables the user to more easily interact with the scanner 12 such as, in one arrangement, by using a pointing device 30. In one variation, the projection distance is no more than three feet and provides a relatively large high resolution input panel image 28 without requiring the projector 14 to employ a high intensity light source.

A third expression of the embodiment of FIG. 1 is for a scanner assembly 10 including a scanner 12 and at least one projector 14. The scanner 12 is adapted for scanning a document 16 and for generating an input panel image 28. The at least one projector 14 is operatively connected to the scanner 12 and is adapted for optically projecting a preview 18 of a scan of a document 16 scanned by the scanner 12 and for optically projecting the input panel image 28.

It is noted that the implementations, enablements, arrangements, etc. of the first and/or the second expression of the embodiment of FIG. 1 are equally applicable to the third expression of the embodiment of FIG. 1. It is also noted that an embodiment of the scanner assembly 10 may include both a pointing device 30 and a user-interactive input device 26, as shown in the embodiment of FIG. 1.

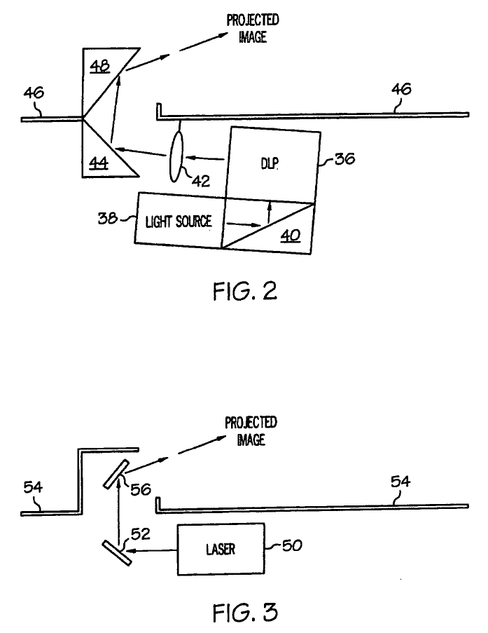

In one employment of the first, second, and/or third expression of the embodiment of FIG. 1, optical projection of the preview 18 and/or the input panel image 28 is implemented by using a digital light processor (DLP) 36 as shown in FIG. 2. The preview 18 is rendered from a scanned document 16. A DLP includes an array of individually controlled micro-mirrors (not shown). A light source 38 is operatively connected through a first mirror 40 to the DLP 36 which projects an image through a lens 42 onto a second mirror 44 disposed below a housing surface 46 of the scanner 12 and then onto a third mirror 48 disposed above the housing surface 46 of the scanner 12. It is noted that unnumbered arrows indicate the light path between projector components. In another employment, a liquid crystal modulator (LCD), not shown, replaces the DLP 36. It is noted that conventional computer projectors include those which utilize a DLP or a LCD to project computer images onto a large screen. Since the projection distance is relatively short (typically three feet or less) for the scanner assembly 10, the light source 38 need not be of high intensity as found in typical computer projection systems. In one variation, not shown, a color wheel is incorporated between the light source 38 and the first mirror 40, and associated controls are employed, to project a color display.

In a different employment of the first, second, and/or third expression of the embodiment of FIG. 1, optical projection of the preview 18 and/or the input panel image 28 is implemented by using a controlled laser light source 50 as shown in FIG. 3. The laser light beam is reflected off a first rotatably-controlled mirror 52 disposed below a housing surface 54 of the scanner 12 and then onto a second rotatably-controlled mirror 56 disposed above the housing surface 54 of the scanner 12. It is noted that unnumbered arrows indicate the laser-beam light path between projector components. The motors for controlling the rotation of the first and second rotatably-controlled mirrors 52 and 56 have been omitted from FIG. 3 for clarity. An example of a projector using a conventional controlled laser light source is a printer which is based on electro photography. However, instead of imaging the scan of the document onto a photo-sensitive drum as is done by the conventional printer, the scanner assembly 10 projects the scan of the document as a preview. In one variation, the controlled laser light source 50 is an infrared laser, such as a printing laser. In another variation, the controlled laser light source 50 may be a non-infrared laser, such as a neon laser, argon laser, or carbon dioxide laser.

In one configuration of the first, second and/or third expression of the embodiment of FIG. 1, the projector 14 (i.e., the at-least-one projector 14) includes a printing laser or a printing LED (light-emitting-diode) array adapted to project a preview 18 and/or an input panel image 28 and also adapted to project a scan of a document onto a photo-sensitive drum for a printing mode based on electro photography.

In one utilization for any employment involving optical projection of the input panel image 28, user interaction with the input panel image 28 is sensed using camera methods, optical methods, and/or resistive/pressure sensitive touch screens. In this utilization, camera systems, optical systems, and/or touch screens track the user's hands to interact with the projected input panel image 28.

The foregoing description of several expressions of an embodiment of the invention has been presented for purposes of illustration. It is not intended to be exhaustive or to limit the invention to the precise forms and/or steps disclosed, and obviously many modifications and variations are possible in light of the above teaching. It is intended that the scope of the invention be defined by the claims appended hereto.

What is claimed is:

1. A scanning assembly comprising:
a) a scanner adapted for scanning a document; and
b) a projector operatively connected to the scanner and adapted for optically projecting a preview of a scan of a document scanned by the scanner.

2. The scanning assembly of claim 1, wherein the scanning assembly is a scanning assembly of an all-in-one machine.

3. The scanning assembly of claim 1, wherein the scanner includes a substantially flat surface, and wherein the projector is adapted for optically projecting the preview onto the substantially flat surface.

4. The scanning assembly of claim 3, wherein the substantially flat surface is a substantially flat surface of a platen cover of the scanner.

5. The scanning assembly of claim 1, wherein the scanner also includes a user-interactive input device adapted to adjust a scan parameter observable from the projected preview.

6. The scanning assembly of claim 5, wherein the parameter is chosen from the group consisting of brightness, contrast, cropping, scaling, and translation.

7. The scanning assembly of claim 1, wherein the projected preview has an area of at least twenty-five percent of the area of the document.

8. The scanning assembly of claim 1, wherein the projector includes at least one from the group consisting of a printing laser and a printing LED (light-emitting-diode) array.

9. A scanning assembly comprising:
a) a scanner adapted for generating an input panel image; and
b) a projector operatively connected to the scanner and adapted for optically projecting the input panel image.

10. The scanning assembly of claim 9, wherein the scanning assembly is a scanning assembly of an all-in-one machine.

11. The scanning assembly of claim 9, wherein the scanner includes a substantially flat surface, and wherein the projector is adapted for optically projecting the input panel image onto the substantially flat surface.

12. The scanning assembly of claim 1, wherein the substantially flat surface is a substantially flat surface of a platen cover of the scanner.

13. The scanning assembly of claim 9, further comprising a pointing device adapted for user interaction with the projected input panel image.

14. The scanning assembly of claim 13, wherein the projected input panel image includes a scan-parameter panel-button image portion chosen from the group consisting of a brightness panel-button image portion, a contrast panel-button image portion, a cropping panel-button image portion, a scaling panel-button image portion, and a translation panel-button image portion.

15. The scanning assembly of claim 14, wherein the projected input panel image also includes a scan-destination panel-button image portion chosen from the group consisting of an email-destination panel-button image portion, a facsimile-destination panel-button image portion, and a print-destination panel-button image.

16. The scanning assembly of claim 9, wherein the projector includes at least one from the group consisting of a printing laser and a printing LED (light-emitting-diode) array.

17. A scanning assembly comprising:
a) a scanner adapted for scanning a document and for generating an input panel image; and
b) at least one projector operatively connected to the scanner and adapted for optically projecting a preview of a scan of a document scanned by the scanner and for optically projecting the input panel image.

18. The scanning assembly of claim 17, wherein the scanning assembly is a scanning assembly of an all-in-one machine.

19. The scanning assembly of claim 17, wherein the scanner includes at least one substantially flat surface, and wherein the at-least-one projector is adapted for optically projecting the preview and the input panel image onto the at-least-one substantially flat surface.

20. The scanning assembly of claim 19, wherein the at-least-one substantially flat surface is a substantially flat surface of the platen cover of the scanner.

21. The scanning assembly of claim 17, further comprising a pointing device adapted for user interaction with the projected input panel image.

22. The scanning assembly of claim 21, wherein the projected input panel image includes a scan-parameter panel-button image portion chosen from the group consisting of a brightness panel-button image portion, a contrast panel-button image portion, a cropping panel-button image portion, a scaling panel-button image portion, and a translation panel-button image portion.

23. The scanning assembly of claim 17, wherein the at-least-one projector includes at least one of the group consisting of a printing laser or a printing LED (light-emitting-diode) array.
